(19) United States
(12) Patent Application Publication
(10) Pub. No.: US 2017/0203466 A1
(43) Pub. Date: Jul. 20, 2017

(54) AUTO-DEPLOYING VERTICAL BAND SAW GUARD

(71) Applicant: Triodyne Safety Solutions, L.L.C., Glenview, IL (US)

(72) Inventor: Ralph Lipsey BARNETT, Wilmette, IL (US)

(21) Appl. No.: 15/246,892

(22) Filed: Aug. 25, 2016

Related U.S. Application Data
(60) Provisional application No. 62/280,316, filed on Jan. 19, 2016.

(51) Int. Cl. B27G 19/06

(52) U.S. Cl. CPC B27G 19/06

(57) ABSTRACT

The present invention is a guard system for a band saw. The guard system moveable from a guarded position, covering a saw blade, to an exposed position, exposing the saw blade for cutting, with an actuator operable with a foot control.

### CROSS REFERENCE TO RELATED APPLICATION

This Patent Application claims the benefit of U.S. provisional patent application, Ser. No. 62/280,316, filed on 19 Jan. 2016, and is hereby incorporated by reference in its entirety and is made a part of this specification, including but not limited to those portions which specifically appear in this specification.

### BACKGROUND OF THE INVENTION

Field of the Invention

This invention is directed to a guard for a band saw that automatically deploys to cover an unprotected portion of a saw blade when an operator steps away from the band saw to prevent injuries to the operator or others. More specifically, this invention is directed to a guard for a band saw that is biased in a downward, protected position with a pneumatic actuator, a spring and treadle, or with another device. A foot pedal or another type of switch may be used to move the guard to an operational position, exposing the saw blade to cut materials.

Discussion of Related Art

All modern vertical band saws for cutting wood, metal, plastic and meat are equipped with a blade guard that protects a saw blade moving between the band saw housing and the blade guide. A portion of the blade passing below the blade guide remains exposed allowing a user to cut various materials including wood, metal, plastic, or meats. The exposed portion of the blade is set by adjusting and clamping the blade guide to a desired position with a simple screw-type clamp. Because the blade guide and the associated blade guard are set and locked in position, the exposed band saw blade presents a constant hazard to personnel operating or moving in the vicinity of the band saw. As such, there is a need for an improved band saw guard that covers the exposed saw blade when not in use and does not significantly impede the operators work.

### SUMMARY OF THE INVENTION

A general object of the invention is to provide an improved blade guard for a band saw that automatically deploys to protect operators and others from injury.

Known band saws generally include a continuous saw blade loop that is driven by a motor around two wheels. Known band saws further include a housing covering a majority of the saw blade except for a gap in the housing where an operator cuts wood or another type of material. This exposed portion of the saw blade can be dangerous for the user or another person. The invention of this application minimizes this danger by automatically covering the exposed blade when not in use.

In a preferred embodiment of this invention, the band saw includes a guard system to cover the exposed section of the saw blade when not in use. The guard system includes an actuator, a guide rail, a blade guide, and a blade guard. The blade guard preferably includes a collapsible cover that at least partially surrounds the exposed section of the saw blade to prevent unintentional contact and injury. In a preferred embodiment of this invention, a screw clamp is removed from the guide rail, allowing the connected guide rail and blade guard to slide down to contact the table and, preferably, completely enclose every portion of the saw blade that was previously exposed in the prior art. The actuator connects to the guide rail to move the blade guard system. When the operator wants to expose the saw blade for cutting, he or she activates the actuator to pull on the guide rail to raise the blade guard exposing the saw blade.

In an embodiment of this invention, the downward movement of the guide rail, the blade guide and the blade guard may be imposed by gravity. In a preferred embodiment, the guard system is biased downwards towards the table. The bias may be provided, for example but not limited to, by a pneumatic two-way cylinder and/or a simple linkage system using a spring and treadle. This invention urges the blade guard downward to contact the table improving the safety of the band saw by preventing or minimizing unintentional contact with the saw blade.

In a preferred embodiment of this invention, the actuator comprises a two-way pneumatic cylinder and a foot control. To use the band saw of this invention, the two-way pneumatic cylinder is activated with a foot control which lifts the guide rail, the blade guide and blade guard to a desired height set by a variable positioned clamp attached to the guide rail. As long as the foot control is depressed, the saw blade is exposed at a predetermined height for operation. When the foot control is released, gravity and/or the two-way pneumatic cylinder closes the guard system over the previously exposed portion of the saw blade and into a protected position. When the foot pedal is released, preferably, there is a lower limit stop which prevents the upper guide rail, blade guide and blade guard system from impacting into the table. Preferably, there is also an upper limit stop that will prevent the blade guides from impacting the band saw housing. When the foot control is activated, the adjustable clamp, which is attached to the upper guide rail, is forced up against the band saw housing. This allows a predetermined height for the exposed band saw blade. It should be noted that a one-way cylinder actuator can be substituted for the two-way cylinder previously described. The one-way cylinder would be urged into a downward position by gravity or spring forces. In another alternative embodiment, a spring and treadle system or another mechanical device may replace the pneumatic cylinder.

In a preferred embodiment of this invention, the reciprocating guide rail, the blade guide, the blade guard system further includes cushioning at the upper and/or the lower limit stops. Alternatively, action of the pneumatic cylinder may be cushioned with additional pneumatic devices.

### BRIEF DESCRIPTION OF THE DRAWINGS

These and other objects and features of this invention will be better understood from the following detailed description taken in conjunction with the drawings, wherein:

FIG. 1 is a front perspective view of a band saw with a guard according to an embodiment of this invention, with the guard in a lower, protected position.

FIG. 2 is a rear perspective view of the band saw and the guard shown in FIG. 1.

FIG. 3 is a close-up perspective view of the guard shown in FIG. 1.

FIG. 4 is a side view of the band saw and the guard shown in FIG. 1 with a portion of a housing removed.

FIG. 5 is another side view of the band saw and the guard shown in FIG. 1 with the portion of a housing removed.

FIG. 6 is a side cross-sectional view of a band saw with a guard according to an embodiment of this invention, with the guard in a lower, protected position.

FIG. 7 is another side cross-sectional view of the band saw and the guard of FIG. 6, with the guard in a raised, operational position.

### DETAILED DESCRIPTION OF PREFERRED EMBODIMENTS

As shown in the figures, the present invention provides a band saw 10 with a guard system 12 which operates to prevent accidental contact with a saw blade 14 when the band saw 10 is not in use.

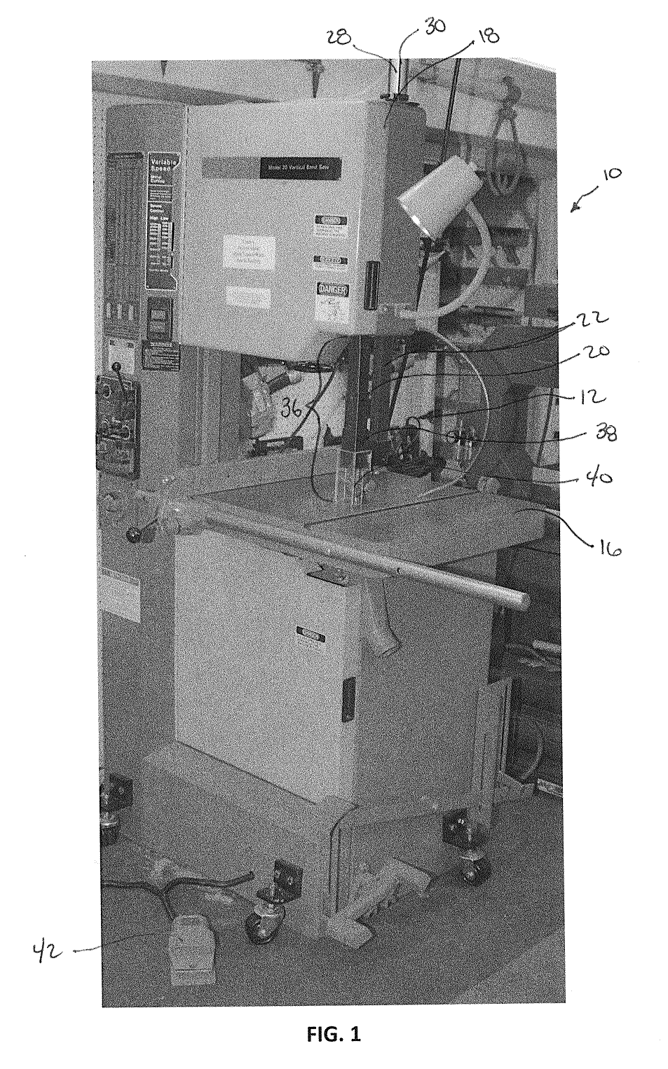

FIG. 1 shows an embodiment of the band saw 10 with the guard system 12 of this invention. In this embodiment, the band saw 10 includes a saw blade 14 which comprises a continuous, flexible loop with saw teeth which is driven about a plurality of wheels 34 by a motor, not shown. The band saw 10 further includes a housing 18 that encloses the wheels 34, motor, and a majority of the saw blade 14. A gap 36 in the housing 18 exposes a section of the rotating saw blade 14 in order to cut materials. While necessary, the exposed portion of the moving saw blade presents a danger of accidental contact. The guard system 12 of this invention attempts to minimize this danger by automatically covering the exposed portion of the moving saw blade 14 when not in use.

In a preferred embodiment, the band saw 10 further includes a table 16, at a lower portion of the gap 36, to support the material during cutting.

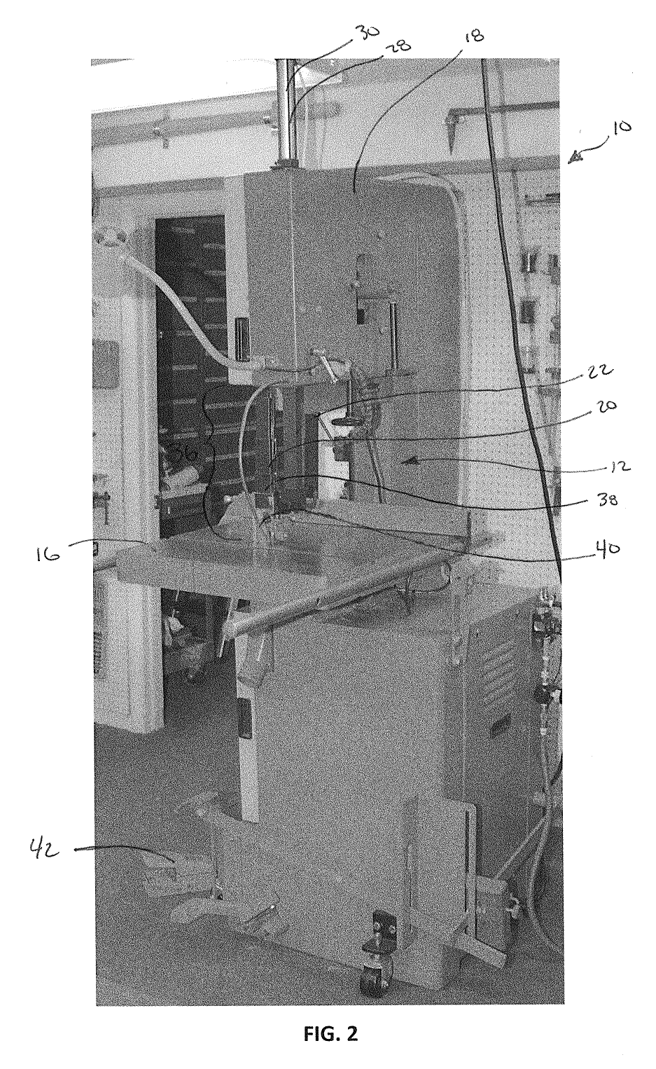

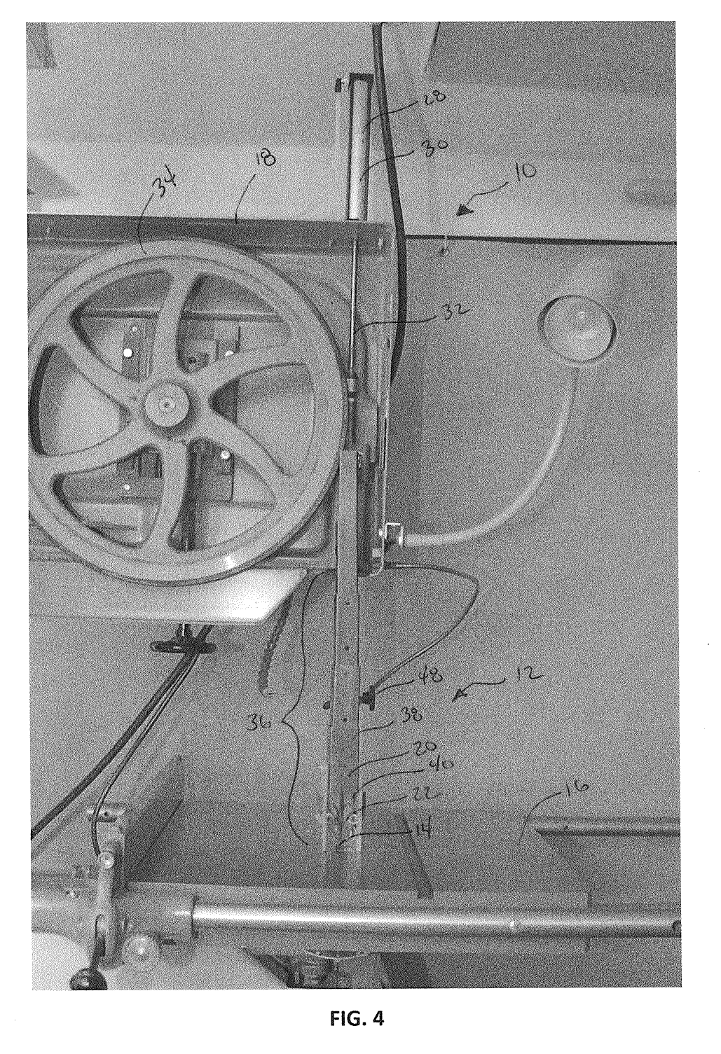

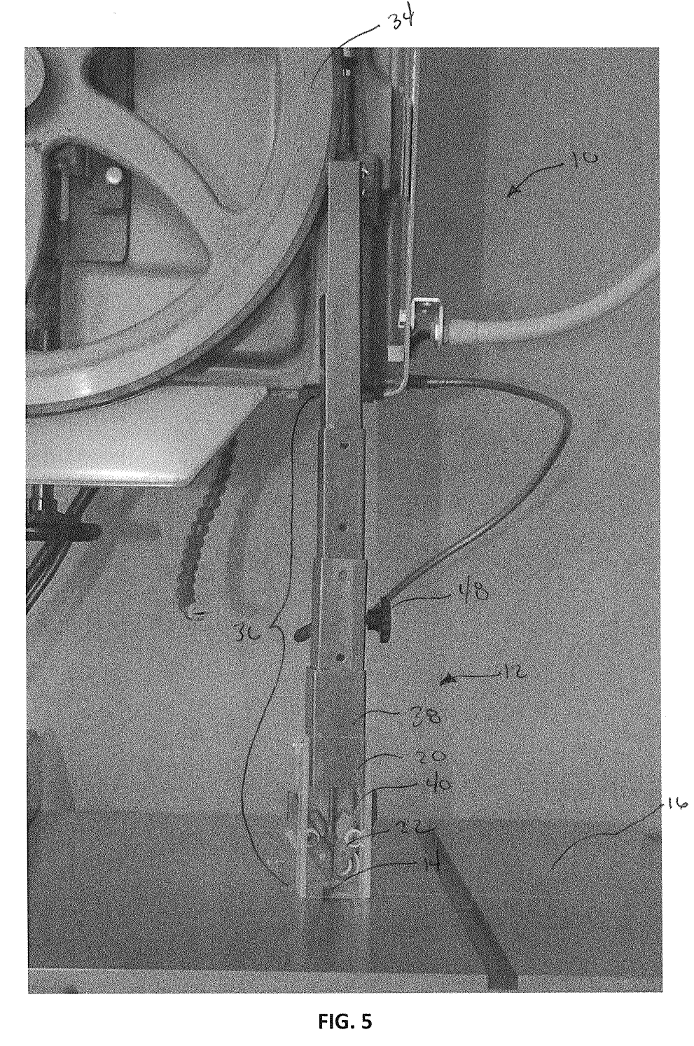

In the embodiment of the invention shown in FIGS. 1-5, the guard system 12 includes a blade guard 20 surrounding the saw blade 14 passing through the gap 36. In this embodiment, the blade guard 20 is a plurality of nested, square tubing 38 with a clear section 40 surrounding the lower portion of the saw blade 14 in proximity to the table 16. In this embodiment, as best shown in FIGS. 4 and 5, the plurality of nested, square tubing 38 are mounted to the housing 18 and surround the saw blade 14. The nested configuration allows the blade guard 20 to be collapsed and expanded allowing the blade guard to move from a lower, protected position guarding the saw blade to a raised, operational position exposing the saw blade 14 for cutting a material. In a preferred embodiment, the plurality of nested, square tubing 38 is manufactured from a metal material that is able to withstand contact with the saw blade 14 and to protect an individual from injury. However, the tubing need not be manufactured of metal and may comprise any material that can prevent injury due to accidental contact with the saw blade 14. Additionally, the tubing may comprise any shape and may not comprise a square shape.

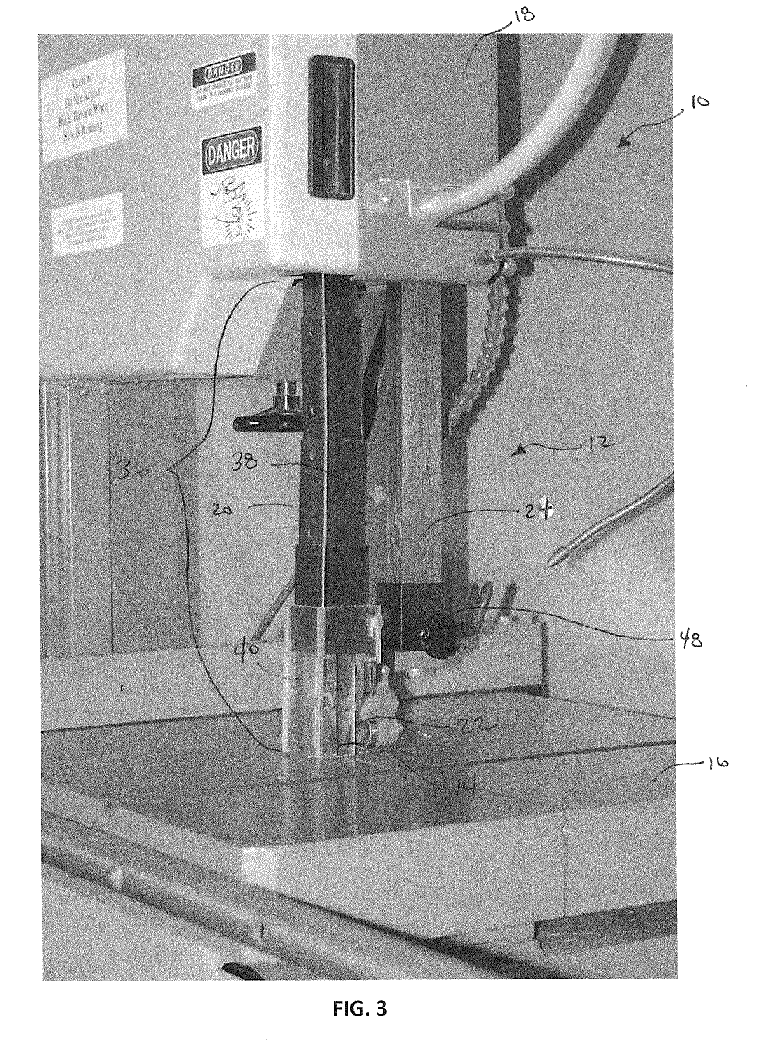

In the embodiment of FIGS. 1-5, the lower section of the blade guard 20 is a clear section 40 that allows the user to line up the material to the saw blade 14 without exposing the blade. In a preferred embodiment, the clear section 40 comprises clear acrylic. However, the clear section may be made of any material that can prevent accidental contact with the saw blade and may or may not be clear. In this embodiment, the clear section 40 is connected to the lower edge of the nested tubing 38 with a pivot connection which allows slight movement of the clear section 40 to ease the movement of the material under the clear section 40 during cutting. Alternatively, the clear section 40 may include a guide or a friction reducing surface to ease the movement of the material under the blade guard 20. As best shown in FIG. 3, the clear section 40 covers three sides of the saw blade 14 including an edge of the blade with cutting teeth. This design allows for easy access to a blade guide 22 while covering the teeth.

The guard system 12 of this invention further includes components to move the blade guard 20 from a lower, protected position to a raised, operational position for cutting materials. In an embodiment of this invention, shown in FIG. 3, the components for moving the blade guard 20 preferably include a guide rail 24, a cylinder rod 32, FIG. 4, and an actuator 28. In a preferred embodiment, movement of the guard system 12 of this invention is provided by the actuator 28 with the cylinder rod 32 connected to the guide rail 24. The actuator 28 preferably comprises a pneumatic cylinder 30. The guide rail 24 is connected to the blade guard 20 to move the blade guard 20 when the pneumatic cylinder 30 articulates the cylinder rod 32. The pneumatic cylinder 30 preferably connects to a tethered foot control 42 by a pneumatic circuit. The basic operation of the machine is similar to previously known band saws with an additional step requiring the operator to step on the foot control 42 during operations to expose the saw blade. In a preferred embodiment, the pneumatic cylinder 30 is a two-way pneumatic cylinder however, the pneumatic cylinder 30 may also be a one-way cylinder. In an alternative embodiment, the actuator 28 may instead comprise a hydraulic cylinder, a spring and treadle system, an electrical system, a magnetic system or any other type of device for moving the guard system 12 to expose the saw blade 14. Similarly, it should be understood that the foot control 42 may be replaced with another type of a switch for articulating the guard system 12 for example, but not limited to, a hand control or a treadle step system that extends around a base of the band saw 10 allowing an operator to operate the guard system 12 at multiple positions around the base.

In a preferred embodiment, the guard system 12 is maintained in a generally aligned manner with the saw blade 14 by a bearing block 26. In one embodiment, the bearing block 26 is preferably connected to the housing 18 with a plurality of fasteners. The bearing block 26 further includes a pair of slots, wherein one of the slots allows for the blade guard 20 and the saw blade 14 to pass through and the other slot allows for the guide rail 24 to pass through. In a preferred embodiment, the bearing block includes bearings in at least one of the slots to minimize friction between the bearing block 26 and the blade guard 20 and/or the guide rail 24. Alternatively, the slots may include a lubricant, such as graphite, and/or a low-friction surface, such as nylon, to minimize friction.

The band saw 10 of this embodiment further includes a variable height clamp 48 that is removably connectable to the guide rail 24 to limit movement of the guard system 12 to adjust the amount of exposure of the saw blade 14.

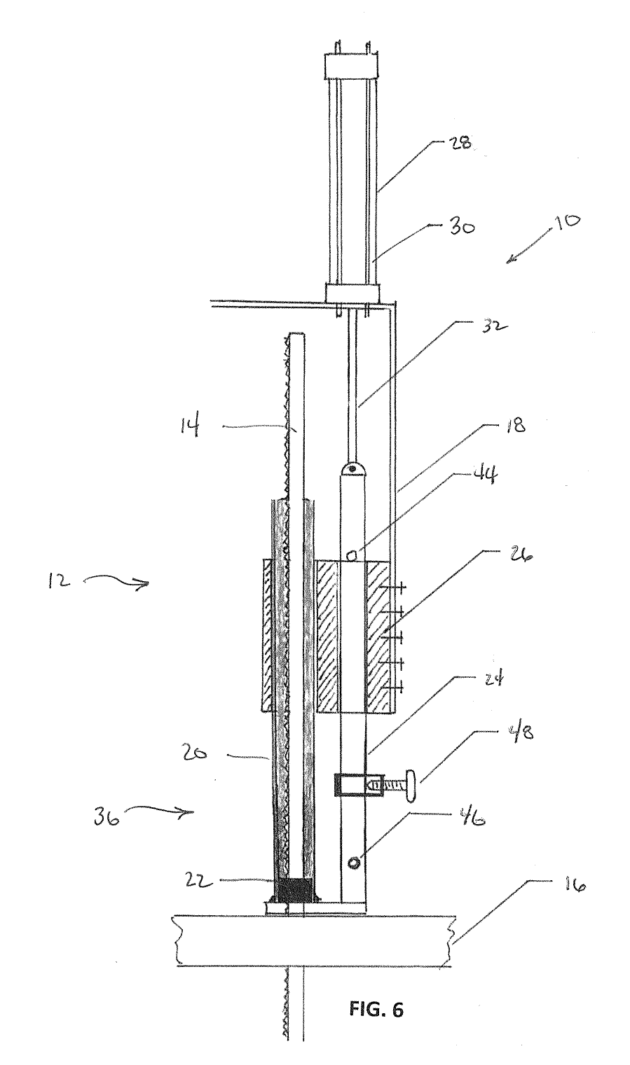

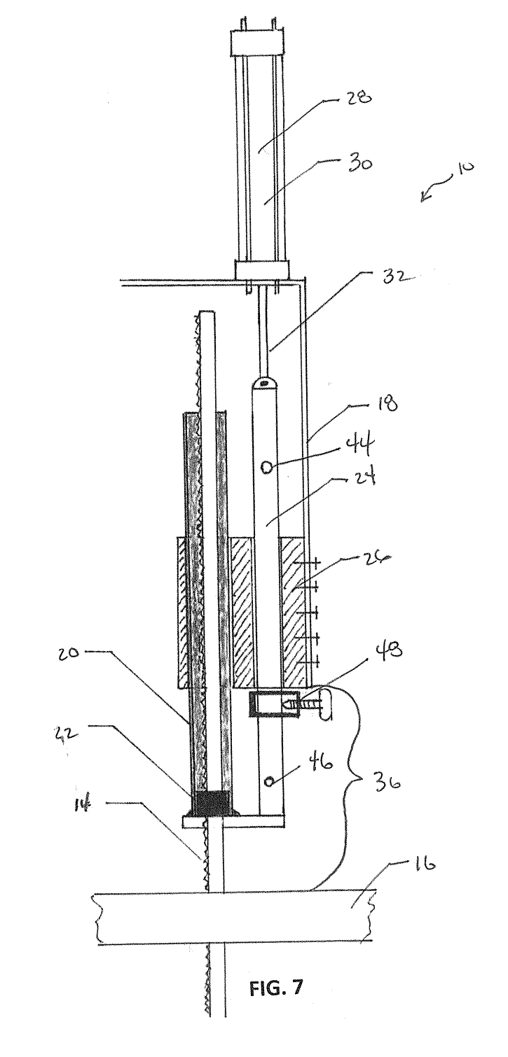

FIGS. 6 and 7 show a cross-sectional view of the guard system 12 according to another embodiment of this invention. Like above, this embodiment includes the blade guard 20, the blade guide 22, the guide rail 24, the bearing block 26, and the actuator 28. The blade guard 20 surrounds a portion of the saw blade 14 that is not positioned within the housing 18 of the band saw 10 and the blade guide 22 surrounds the saw blade 14 at a lower end of the blade guard 20. In operation, the blade guard 20 and the blade guide 22 may be raised to expose a portion of the saw blade 14 to cut the material. In an alternative embodiment, the blade guard 20 may not completely surround the saw blade 14 and may only cover teeth of the saw blade 14.

In this embodiment, the guard system 12 is maintained in a generally aligned manner with the saw blade 14 by the bearing block 26. The bearing block 26 is preferably connected to the housing 18 with a plurality of fasteners. The bearing block 26 further includes a pair of slots, wherein one of the slots allows for the blade guard 20 and the saw blade 14 to pass through and the other slot allows for the guide rail 24 to pass through. Movement of the guard system 12 of this embodiment is provided by the actuator 28 and a cylinder rod 32 connected to the guide rail 24. Preferably, the actuator 28 comprises a two-way pneumatic cylinder 30 with a tethered foot control and a pneumatic circuit. The basic operation of the machine is similar to previously known band saws with an additional step requiring the operator to step on the foot control during operations to expose the saw blade.

In this embodiment, the guide rail 24 includes a lower limit stop 44 and an upper limit stop 46. The lower limit stop 44 and the upper limit stop 46 are positioned on the guide rail 24 to impact the bearing block 26, the housing 18, or the table 16 to limit the movement of guard system 12. In another embodiment, the band saw 10 further includes the variable height clamp 48 that is removably connectable to the upper guide rail 24 to limit movement of the guard system 12 to adjust the amount of exposure of the saw blade 14.

Thus, the present invention provides an improved guard system for a band saw which limits exposure of a saw blade to prevent injuries.

While in the foregoing specification this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A band saw comprising:
a continuous saw blade;
a housing surrounding a portion of the continuous saw blade except for a portion of the saw blade moving through a gap in the housing;
a moveable blade guard surrounding at least a portion of the saw blade moving through the gap in the housing, wherein the moveable blade guard is moveable from a guarded position to an operational position for cutting a material; and
an actuator to move the blade guard from the guarded position to the operational position.

2. The band saw of claim 1, further including:
a foot control connected to the actuator to control movement of the blade guard from the guarded position to the operational position.

3. The band saw of claim 1 wherein the actuator comprises a pneumatic cylinder.

4. The band saw of claim 4 wherein the pneumatic cylinder is a two-way cylinder.

5. The band saw of claim 1 wherein the actuator comprises a spring and treadle system.

6. The band saw of claim 1, further including:
a guide rail connected to the blade guard and wherein the actuator acts on the guide rail to move the blade guard from the guard position to the operational position.

7. The band saw of claim 6, further including:
at least one of an upper limit stop and a lower limit stop positioned on the guide rail to restrict the movement of the movable blade guard.

8. The band saw of claim 6, further including:
an adjustable clamp mountable to the guide rail to restrict the movement of the movable blade guard.

9. A guard system for a saw comprising:
a blade guard surrounding a saw blade and moveable from a guarded position covering the saw blade to an operational position exposing the saw blade for cutting;
an actuator connected to the blade guard to move the blade guard from the guarded position to the operational position, wherein the blade guard is biased to the guarded position and the actuator moves the blade guard to the operational position; and
a switch connected to the actuator to control movement of the blade guard from the guarded safe position to the exposed position.

10. The guard system for the band saw of claim 9 wherein the actuator comprises a pneumatic cylinder.

11. The guard system for the band saw of claim 10 wherein the pneumatic cylinder is a two-way cylinder.

12. The guard system for the band saw of claim 9 wherein the actuator comprises a spring and treadle system.

13. The guard system for the band saw of claim 9, further including:
a bearing block to maintain an alignment of the blade guard.

14. The guard system for the band saw of claim 13, wherein the bearing block includes at least one of a bearing and a lubricant to minimize friction between the bearing block and the moveable blade guard.

15. The band saw of claim 13, further including:
an upper limit stop, a lower limit stop and an adjustable clamp to restrict the movement of the movable blade guard.

16. A band saw comprising:
a continuous saw blade driven to cut a material;
a housing surrounding a substantial portion of the continuous saw blade except for a cutting portion of the continuous saw blade;
a moveable blade guard surrounding at least a portion of the cutting portion of the saw blade, wherein the moveable blade guard is moveable from a guarded position to an exposed position for cutting a material; and
an actuator connected to the blade guard with a guide rail, wherein the moveable blade guard is biased in the guarded position and the actuator moves the blade guard to the exposed position.

17. The band saw of claim 16, further including:
a foot control connected to the actuator to control movement of the blade guard from the guarded position to the exposed position.

18. The band saw of claim 16 wherein the actuator comprises a pneumatic cylinder.

19. The band saw of claim 16, further including:
a bearing block connected to the housing, wherein the bearing block includes a pair of slots to maintain an alignment of the moveable blade guard, wherein the first slot receives the moveable blade guard and the second slot receives the guide rail.

20. The band saw of claim 19 wherein the bearing block includes at least one of a bearing and a lubricant to minimize friction between the bearing block and the moveable blade guard.
